(19) United States
(12) Patent Application Publication
(10) Pub. No.: US 2025/0279639 A1
(43) Pub. Date: Sep. 4, 2025

(54) Non-metallic Open Back Box Assembly for Use in Electrical Branch Wire Fabrication

(71) Applicant: Bruce G. Phillips, Boca Raton, FL (US)

(72) Inventor: Bruce G. Phillips, Boca Raton, FL (US)

(21) Appl. No.: 19/070,290

(22) Filed: Mar. 4, 2025

Related U.S. Application Data
(60) Provisional application No. 63/561,006, filed on Mar. 4, 2024.

(51) Int. Cl. H02G 3/14; H02G 3/08; H02G 3/12

(52) U.S. Cl. CPC H02G 3/14; H02G 3/081; H02G 3/088; H02G 3/123

(57) ABSTRACT

The present invention provides a junction box assembly with a non-metallic junction box. A rear cover plate may be removably attached to the non-metallic junction box. A mounting plate may be fixed to a framing member and connected to the non-metallic junction box such that the mounting plate allows the junction box assembly to rotate relative to the framing member. A vapor proof ring may be disposed between the non-metallic junction box and a wall substrate to form a seal between the non-metallic junction box and the wall substrate. An adapter plate may cover a portion of the non-metallic junction box and may limit the number of wiring devices that may be attached to the non-metallic junction box.

### CROSS-REFERENCE TO RELATED APPLICATIONS

This application claims priority from U.S. Provisional Patent Application No. 63/561,006, filed Mar. 4, 2024, which is hereby incorporated by reference.

### BACKGROUND OF THE INVENTION

The present invention relates to prefab wiring and in particular to a plastic open back box.

U.S. Pat. No. 8,168,887 filed by the present inventor includes a method for an open back box for use in prefabrication of electrical branch wiring systems. The intended purpose of the '877 patent is for commercial projects using steel boxes. However, for small residential projects, with wood framing, and using Non-Metallic Cable (NM-B, a/k/a common trade name: Romex), steel boxes with plaster rings and other required components are not economically feasible. The primary reason to utilize any prefabricated system is ultimately to save money. But more expensive products such as metallic junction boxes, and required labor to assemble and install said products, erode any economic value when applied to projects with wood framings and NM-B cable. Hence, a need exists for a product that will achieve economic advantage and can be employed in a prefabricated system.

The industry has, for many decades, offered inexpensive nonmetallic junction boxes (NMJB) fabricated from, for example, PVC, other plastics, and/or fiberglass. The NMJB are available in various sizes, types, adjustable and non-adjustable varieties. However, NMJB are not suitable for use in prefabrication, where a wiring device is preinstalled at a prefabrication facility (on, or off the job-site premises) because the wiring device will require removal, and then reinstallation, if additional cable(s) are required to be installed in the NMJB. Currently available NMJB do not provide access to the interior of the NMJB boxes after installation at a work site (with a wiring device(s) installed on its face). The NMJB also does not include a ground wire attachment, limiting their application.

As previously cited, the '877 patent solved the problem of having to remove a previously installed wiring device(s) from the front of the box to access interior wiring/connections by allowing said access from the back of the junction box. However, even this improvement has its limitations in that for a worker to access the back of the junction box he/she must physically relocate themselves on the other side of a framed wall. It is not always possible to walk through framing members (studs) as they are commonly only 14½″ apart and often blocked with pipes, wires and other features commonly found in construction. And so, the worker must exit the room and walk around to the other side of the framed wall. It is also not uncommon for a framed wall to have one side already covered with drywall or other wall substrate making rear access by the worker to the open-back junction box impossible.

Moreover, NMJBs have a relatively small interior volume (as compared to square metal junction boxes) and therefore have limitations, based on the National Electrical Code, as to how many conductors (wires) may be installed in the NMJB. This further frustrates the efficient use of utilizing NMJBs in both prefabricated systems as well as with traditional installation methods.

The NMJB is also offered in a similar configuration with added features to create an air-tight seal around electrical wires where they enter the box, and where the NMJB comes into contact with the back side of wall substrate, thereby meeting the requirements of current energy codes which aim to minimize air leakage in buildings, typically achieved by using special boxes with features like a gasket or flange to form a seal around the box. These are boxes that prevent air infiltration and moisture vapor from entering the wall cavity through the electrical box opening. These “vapor proof boxes” (VPB) are very expensive (as compared to a standard NMJB). VPB are not required in all applications on a project that requires them, rather, they are typically located on the interior side of exterior walls, preventing air infiltration and moisture vapor through any space between the box and wall substrate.

### BRIEF SUMMARY OF THE INVENTION

The present invention addresses the above and other needs by providing a junction box assembly with a non-metallic junction box (or sometimes “NMJB”). A rear cover plate may be removably attached to the non-metallic junction box. A mounting plate may be fixed to a framing member and connected to the non-metallic junction box by a hinge mechanism such that the mounting plate allows the junction box assembly to rotate relative to the framing member so that it allows access to the open back of the NMJB without the worker having to physically relocate; and allows the use of an open back box on a wall that has been one-sided with drywall or other substrate). A vapor proof ring may be configured between the non-metallic junction box and a wall substrate to form a seal between the non-metallic junction box and the wall substrate that converts a standard non-metallic junction box into a vapor proof box (VPB). An adapter plate that attaches to the face of the non-metallic junction box that increases the number of conductors that may be installed in the box and solves existing problems and expands the opportunity for the electrical contracting industry to utilize prefabricated methods for projects that are extremely cost sensitive.

In accordance with one aspect of the invention, there is provided a junction box assembly having a non-metallic junction box, also referred to as simply a “junction box” herein. The junction box may have a junction box front face, a junction box rear face configured opposite the junction box front face, and junction box sides connecting the junction box front face and the junction box rear face. A rear cover plate may be removably attached to the non-metallic junction box. The rear cover plate may cover at least a portion of the junction box rear face. The rear cover plate may be secured to the junction box by at least one fastener and/or by an interference fit between the rear cover plate and two or more junction box rear grooves. This is not meant to be limiting as there are many mechanical ways to attach the rear cover to the junction box.

In accordance with another aspect of the invention, the rear cover plate is non-metallic.

In accordance with an alternative aspect of the invention, the rear cover plate is metallic and has a ground hump or hole through which a grounding member such as a ground screw is inserted.

In accordance with another aspect of the invention, the junction box assembly has a mounting bracket with a fixed mounting bracket plate and an attachment mounting bracket plate rotatably coupled to one another by a hinge mechanism. The fixed mounting bracket plate may be secured to a framing member such as a wall stud by at least one fastener. The attachment mounting bracket plate may be connected to the junction box. The attachment mounting bracket plate may be rotated relative to the fixed mounting bracket plate to cause the junction box to rotate relative to the framing member to expose the junction box rear face.

In accordance with another aspect of the invention, the attachment mounting bracket plate may be formed integrally with the junction box. Alternatively, the attachment mounting bracket plate may mate with mounting bracket grooves configured in at least one of the junction box sides. A mounting bracket screw may mate with the mounting bracket attachment plate. The mounting bracket screw may be rotated to translate the mounting bracket along the mounting bracket grooves of the junction box side to which it is mated.

In accordance with another aspect of the invention, a method of installing a junction box assembly is provided wherein step one: the worker first secures the fixed mounting bracket plate to the framing member using appropriate fasteners. (In future designs, this plate may be attached by means of an interference fit or by incorporating integrated nail-type features to allow installation via hammering.) Step two, once the fixed plate is mounted, the worker pivots the attachment mounting bracket plate about the mounting bracket hinge, thereby rotating the assembly so that the open rear face is directed toward the work area. Step three: cables are then routed through designated entry openings-whose number and placement vary with the assembly's gang configuration-before individual conductor terminations are made in accordance with job requirements and prevailing industry standards. Step four: after all terminations are completed, the worker closes the open rear by sliding the rear cover plate into the junction box rear grooves until fully seated and then optionally secures it by tightening the retained fastener through the corresponding aperture. Step five: the assembly is rotated back into the stud cavity, and additional fasteners are installed through the attachment plate into the framing member to firmly secure the junction box assembly against further rotation.

In accordance with another aspect of the invention, a vapor proof ring has a vapor proof ring opening that is disposed over the junction box. The vapor proof ring also has a vapor proof ring teeth that engage with serrated tracks on the junction box sides. The engagement of the vapor proof ring teeth with the serrated tracks of the junction box may secure the vapor proof ring over the junction box at least in one direction. Foam may be applied between the vapor proof ring and a wall substrate to form an airtight seal between the vapor proof ring and the wall substrate. Foam with adhesive backing is also furnished as an accessory so the entry points where cable enters the junction box can be sealed too.

In accordance with another aspect of the invention, an adapter plate is secured to the junction box such that it covers a portion of the junction box front face. The adapter plate can be installed on the junction box assembly to convert the junction box from a 4-gang junction box to a 3-gang junction box, from a 3-gang junction box to a 2-gang junction box, or from a 2-gang junction box to a 1-gang junction box. Wiring devices may be attached to the adapter plate by threading fasteners through threaded holes in adapter plate tabs that are secured to adapter plate slots by interference fits.

### BRIEF DESCRIPTION OF DRAWINGS

The above and other aspects, features and advantages of the present invention will be more apparent from the following more particular description thereof, presented in conjunction with the following drawings wherein:

FIG. 1 is a perspective exploded view of a junction box assembly according to the present invention.

FIG. 2 is a front view of the junction box assembly according to the present invention.

FIG. 3 is a top view of the junction box assembly according to the present invention.

FIG. 4 is a side view of the junction box assembly according to the present invention.

FIG. 5 is a perspective view of a mounting bracket according to the present invention.

FIG. 6 is a perspective view of a rear cover plate according to the present invention.

FIG. 7 is a perspective view of a junction box according to the present invention.

FIG. 8 is a perspective view of a mounting bracket screw according to the present invention.

FIG. 9 is a perspective view of a vapor proof ring according to the present invention.

FIG. 10 is a side view of the vapor proof ring according to the present invention.

FIG. 11 is a front view of an adapter plate secured to a junction box according to the present invention.

FIG. 12 is a perspective view of an adapter plate secured to a junction box according to the present invention.

FIG. 13 is a rear view of the junction box assembly according to the present invention.

FIG. 14 is a front view of the junction box assembly according to the present invention.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to descript a feature's appearance to the human eye or human perception, and not a precise measurement, or typically within 10 percent of a stated value.

The terms “non-metallic junction box”, “nonmetallic junction box”, and “NMJB” are used herein and in U.S. provisional patent Application 63/561,006 to describe the junction box assembly of the present invention. These two terms may be used interchangeably to describe the junction box assembly of the present invention. This junction box assembly may be non-metallic. All components of the junction box assembly may be made of a non-metallic material such as but not limited to fiberglass, high-density polyethylene, polyvinyl chloride, polyethylene terephthalate, acrylonitrile butadiene styrene, polyoxymethylene, or any other non-metallic material. Certain components described herein such as but not limited to the grounding member, rear cover plate, mounting bracket, mounting bracket screw, and various fasteners may be metallic even though the junction box assembly overall is referred to as a non-metallic junction box assembly. The junction box component of the junction box assembly in particular may be made of a non-metallic material.

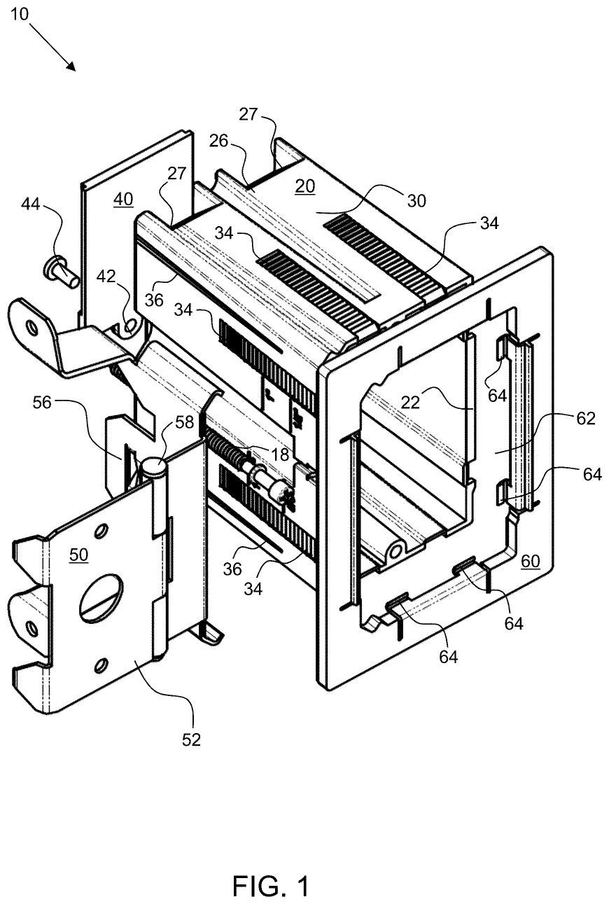

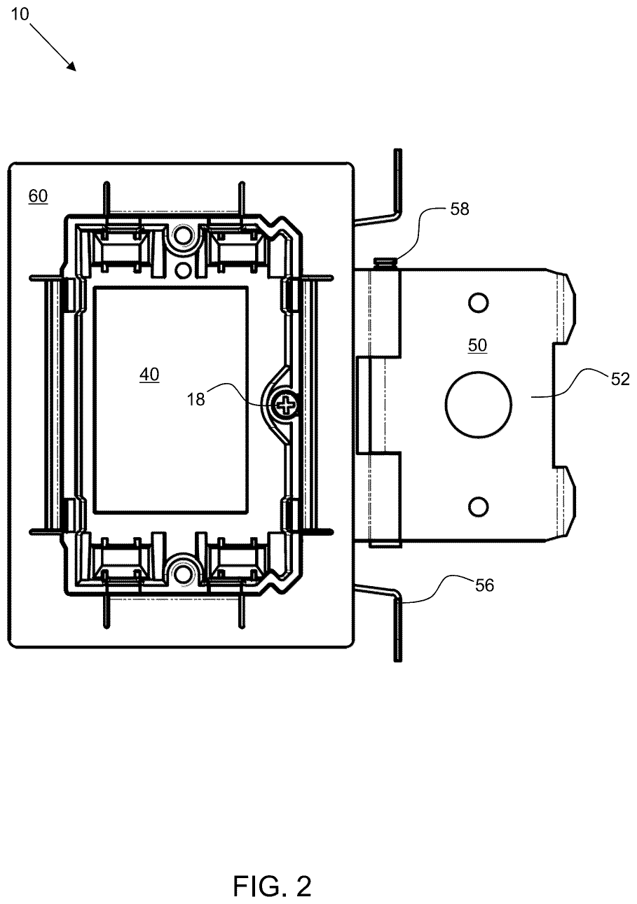

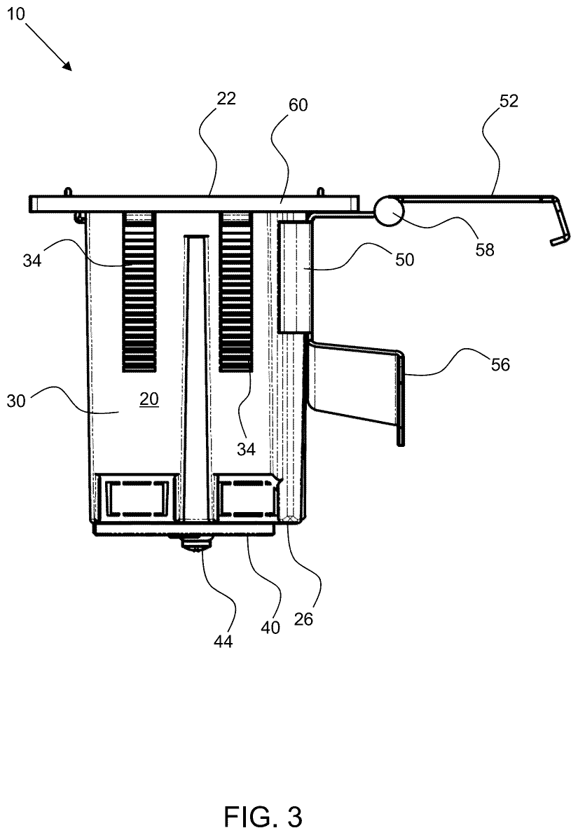

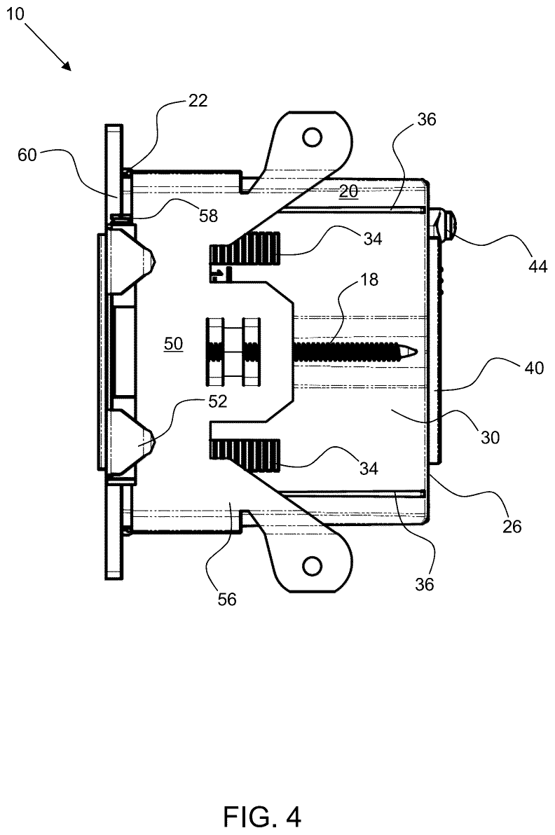

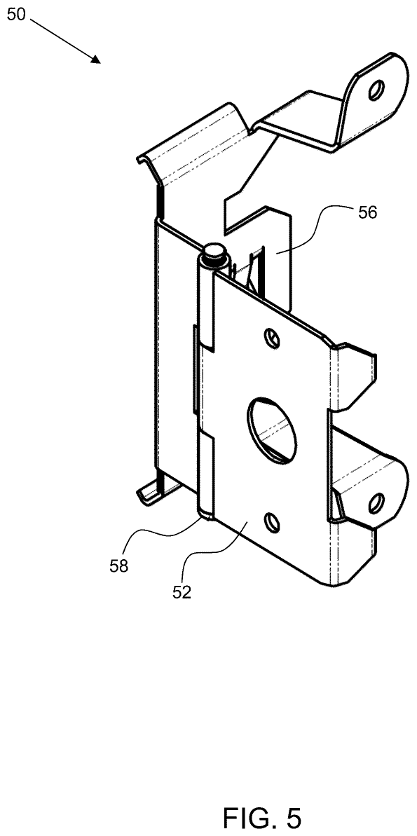

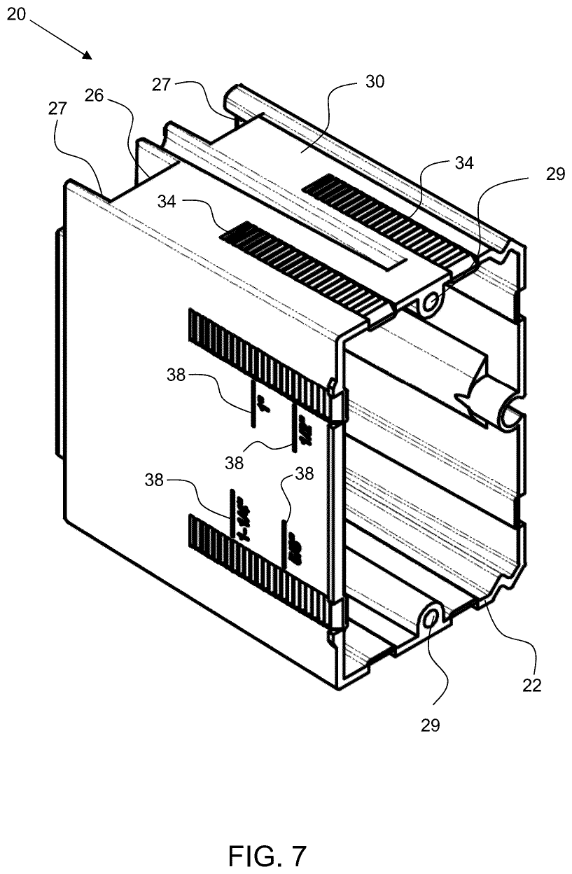

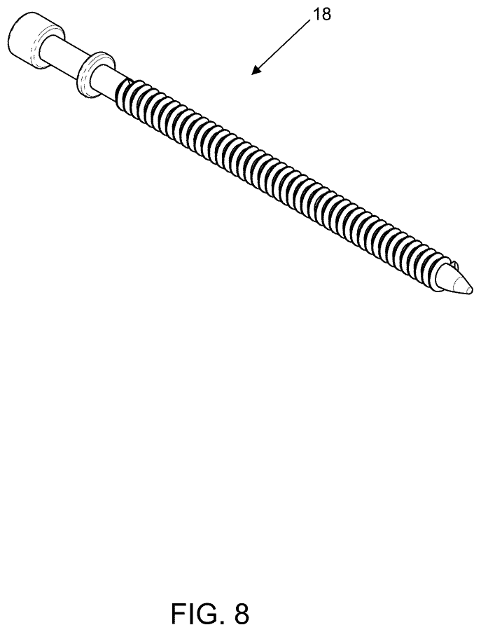

FIG. 1 shows an exploded perspective view of a junction box assembly 10 comprising a junction box 20 (see also FIG. 7) with a junction box front face 22 and a junction box rear face 26 according to the present invention. The junction box front face 22 may be open so that wiring devices, lighting fixtures or other related electrical components may be attached to the junction box front face 22. A wiring device may be any component electrically coupled to a wire, including but not limited to switches, receptacles, timers, dimmers, etc. Low-voltage devices, e.g. telephone, fire alarm, data devices may also be attached to the junction box.

The junction box rear face 26 may also be open. However, the junction box rear face 26 may be covered with a rear cover plate 40. The rear cover plate 40 fits into junction box rear grooves 27 located at the junction box rear face 26. The rear cover plate 40 is removably connected to the junction box by a screw. As shown in FIG. 1, the screw 44 secures the rear cover plate 40 to the junction box 20 at the junction box rear face 26. The screw is inserted through a hole 42 in the rear cover plate 40 and then into a corresponding aperture at the junction box rear face 26 to secure the rear cover plate 40 to the junction box 20. The use of the screw 44 is optional as the interference fit of the cover engaged with the box secures the cover.

The rear cover plate 40 may be made of the same material as the junction box 20, which may be a non-metallic material as described previously herein. Alternatively, the rear cover plate 40 may be made of metal. In preferred embodiments wherein the rear cover plate 40 is made from metal, the rear cover plate 40 may be made from 16-gauge steel to comply with U.S. UL standards and to maintain a 2-hour fire rating for the junction box assembly 10. The rear cover plate 40 may have a ground hump or hole that accepts a standard ground screw (not shown) in embodiments wherein the rear cover plate 40 is made of metal. In embodiments wherein the rear cover plate 40 is made of metal, wiring devices and other electrical components may be bonded to the rear cover plate 40.

A mounting bracket 50 of the junction box assembly 10 has a fixed mounting bracket plate 52 that is attached to a framing member by one or more fastener such as but not limited to nails or screws. The framing member may be a wall stud or the like. The mounting bracket 50 also has an attachment mounting bracket plate 56 that is removably attached to the junction box 20. A portion of the attachment mounting bracket plate 56 is inserted into mounting bracket grooves 36 on the junction box. A mounting bracket screw 18 threadedly engages the mounting bracket 50. Twisting the mounting bracket screw 18 causes the mounting bracket 50 to translate along the mounting bracket grooves 36 towards the junction box front face 22 or towards the junction box rear face 26 depending on the direction in which the mounting bracket screw 18 is twisted. This allows the depth of the junction box 20 within a wall to be adjusted by twisting the mounting bracket screw 18.

The fixed mounting bracket plate 52 and the attachment mounting bracket plate 56 are rotatably connected by a mounting bracket a swivel pin 58. The mounting bracket swivel pin 58 allows the attachment mounting bracket plate 56 to rotate relative to the fixed mounting bracket plate 52. This allows the junction box assembly 10 to swing inward and outward from a wall so that the rear open back side can be easily accessed. To rotatably affix the junction box assembly 10 to a wall, the attachment mounting bracket plate 56 may be mated with the mounting bracket grooves 36 of the junction box 20. The fixed mounting bracket plate 52 may be attached to a framing member such as a stud using nails, screws, or other fasteners such that the junction box front face 22 is facing outward from one side of the wall. The mounting bracket screw 18 may be twisted to translate the junction box 20 further into the wall or further out of the wall. The junction box assembly 10 may then rotate relative to the framing member about the mounting bracket swivel pin 58. This allows access to the junction box rear face 26 to be accessed without having to move to the other side of the wall. This is particularly useful if the other side of the wall is covered by a wall substrate such as drywall.

In addition to being attached to the junction box 20, the attachment mounting bracket plate 56 may be attached to the same framing member as the fixed mounting bracket plate 52 using fasteners. This holds the junction box assembly 10 in one orientation relative to the framing member, which may be beneficial when all electrical components are installed within the junction box 20 and when all wiring devices are attached to the junction box 20, and thereby the junction box rear face 26 no longer needs to be accessed.

A vapor proof ring 60 is attached to the junction box 20 by sliding a vapor proof ring opening 62 over the junction box front face 22. Vapor proof ring teeth 64 mate with serrated tracks 34 on the junction box 20. The number of vapor proof teeth 64 on the vapor proof ring 60 may be equal to the number of serrated tracks 34 on the junction box 20. When the vapor proof teeth 64 mate with the serrated tracks 34, the vapor proof ring 60 may be allowed to translate towards the junction box rear face 26 but not towards the junction box front face 22 due to the angle of mating between the vapor proof teeth 64 and the serrated tracks 34. As shown in FIG. 7, depth markings 38 are provided on at least one of the junction box sides 30. The depth markings 38 correspond with a thickness of wall substrate such as drywall that is installed over the junction box assembly 10. The vapor proof ring 60 may be slid from the junction box front face 22 to the desired depth marking 38. For example, if ⅝ inches of drywall is to be installed over the junction box assembly 10, then the vapor proof ring 60 may be slid over the junction box front face 22 towards the junction box rear face 26 until it reaches a ⅝ in depth marking.

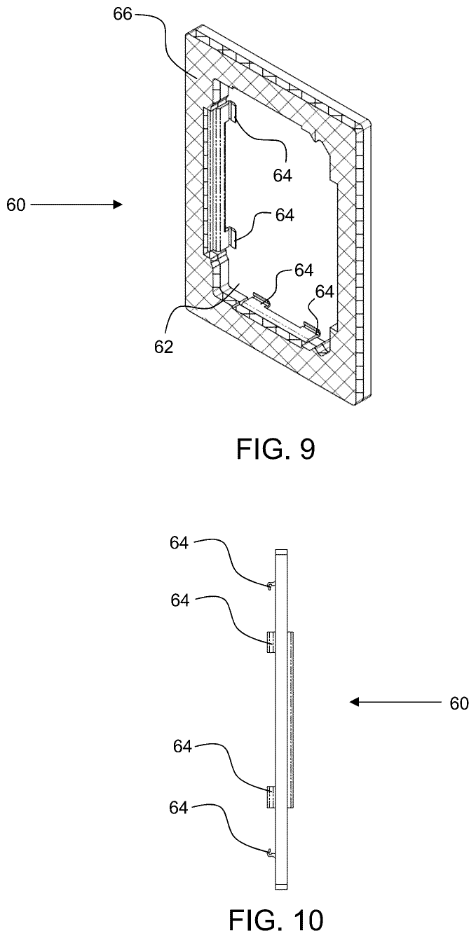

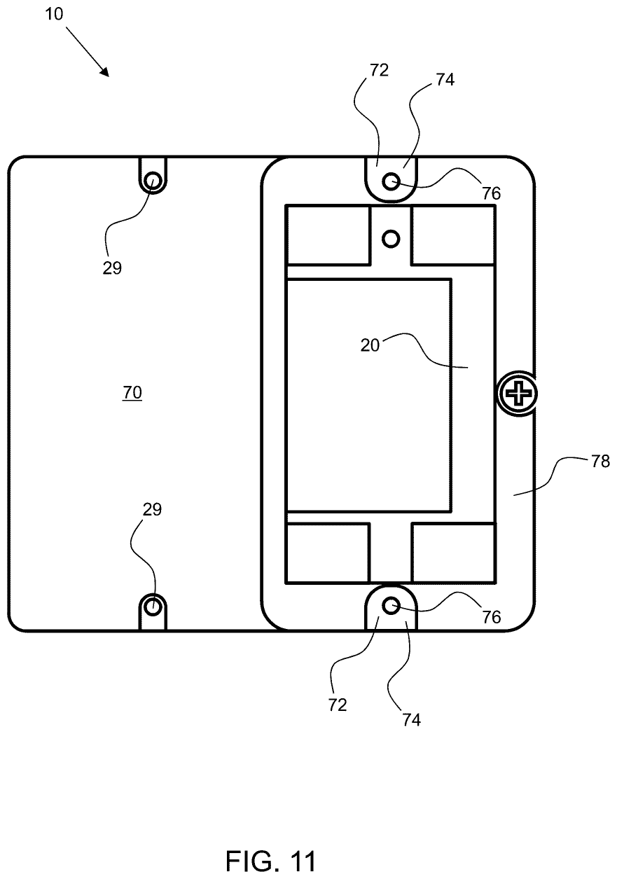

As shown in FIG. 9, foam 66 may at least partially cover one face of the vapor proof ring 60. The foam 66 may be configured between the vapor proof ring 60 and a wall substrate when the junction box assembly is installed in a wall. The foam 66 may form a seal between the vapor proof ring 60 and the wall substrate, which may serve to seal the wall substrate to prevent air filtration and moisture vapor from being transferred through the wall because of space that may exist where the box face 22 (See FIG. 7) has penetrated the wall substrate; additional foam is included (not shown) that seal holes 27 (See FIG. 7) where electrical cables enter the box.

The vapor proof ring 60 allows the junction box assembly 10 to act as a vapor proof box. Vapor proof boxes are used in the industry to meet energy code requirements, but are often expensive and are formed as a single, molded unit. The modular nature of the vapor proof ring 60 of the present invention allows a standard non-metallic junction box to be converted into a vapor proof box if needed, without having to purchase a separate vapor proof box. Furthermore, adjustment of the mounting bracket 50 with the mounting bracket screw 18 allows for the depth of the vapor proof box formed by the vapor proof ring 60 on the junction box assembly 10 to be adjusted relative to wall in which the vapor proof box is installed.

When installed on the junction box assembly 10, the adapter plate 70 covers at least a portion of the junction box front face 22. This prevents wiring devices from being attached to the portion of the junction box front face 22 that is covered by the adapter plate 70. In this manner, a 4-gang junction box may be converted into a 3-gang junction box, a 3-gang junction box may be converted into a 2-gang junction box, and a 2-gang junction box may be converted into a 1-gang junction box. The term “n-gang junction box” refers to a junction box designed to hold n number of wiring devices, where “n” is an integer greater than 0. For example, a 4-gang junction box is designed to hold 4 wiring devices, that may each be inserted into the 4-gang junction box through the junction box front face. Since the adapter plate 70 covers a portion of the junction box front face 22 and prevents wiring devices from being attached to that portion of the junction box front face 22, the adapter plate can convert a n-gang junction box into an m-gang junction box, where “m” is an integer greater than 0 and less than “n”.

One advantage of converting an n-gang junction box into an m-gang junction box is to increase the space inside of the junction box for installing wires and other electrical components. For example, if 2 wiring devices are installed on a 2-gang junction box, there is limited space inside of the junction box to house the wires necessary to provide electricity to the 2 wiring devices. The maximum numbers of wires that may be installed in a junction box, of a given size, is governed by electrical codes. However, if a 4-gang junction box were converted to a 2-gang junction box by blocking half of the junction box front face, then the interior space of the junction box is effectively doubled since the interior space is sufficient for the wiring of 4 wiring devices even though only 2 wiring devices are installed on the junction box.

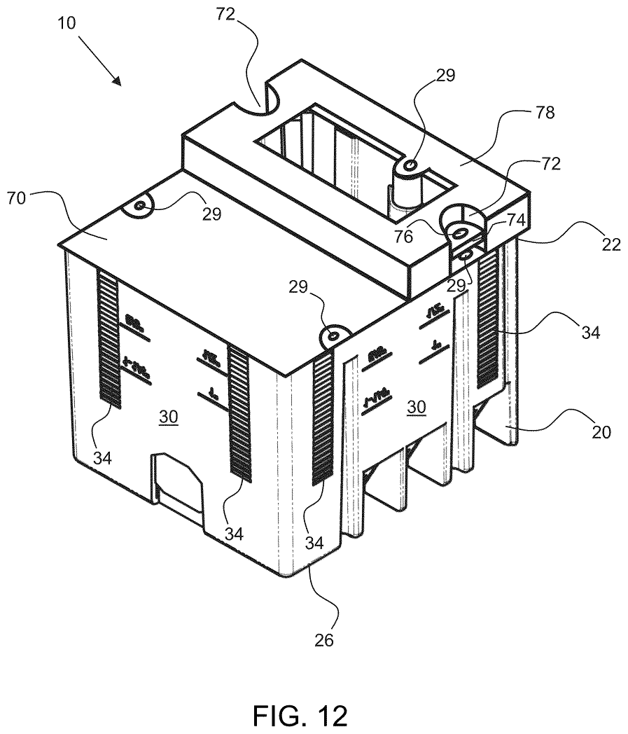

FIG. 12 is a perspective view of an adapter plate 70 secured to the junction box 10. A plaster ring 78 is formed integrally with the adapter plate 70 and may surround the portion of the junction box front face 22 that is accessible when the adapter plate 70 is installed over the rest of the junction box front face 22. The plaster ring 78 may be attached to the junction box 20 with fasteners that are threaded through junction box threaded holes 29 in the junction box 20. The plaster ring 78 may extend from the junction box front face 22 away from the junction box rear face 26.

As shown in FIG. 12, the adapter plate thru holes 29 are used to secure the adapter place to corresponding threaded or formed holes 29 in the junction box. Since the adapter plate 70 and/or plaster ring 78 are secured to the junction box assembly 10 using the adapter plate thru holes 29, another attachment feature must be used to attach wiring devices to the junction box assembly 10. Therefore, the plaster ring 78 has adapter plate slots 72 into which adapter plate tabs 74 are secured using interference fits. The interference fits between the adapter plate slots 72 hold the adapter plate tabs 74 in a fixed position within the adapter plate slots 72 by the force of friction. Each adapter plate tab 74 has an adapter plate threaded hole 76 into which a fastener may be threaded to secure a wiring device to the plaster ring 78.

First the adapter plate 70 must be attached to the junction box through holes 29, and then adapter plate tabs 74 are hand inserted into slots 72 to provide threaded holes for the attachment of wiring device fasterners. When the junction box assembly 10 is installed in a wall, the adapter plate 70 may be positioned between the junction box 20 and a wall substrate such as drywall.

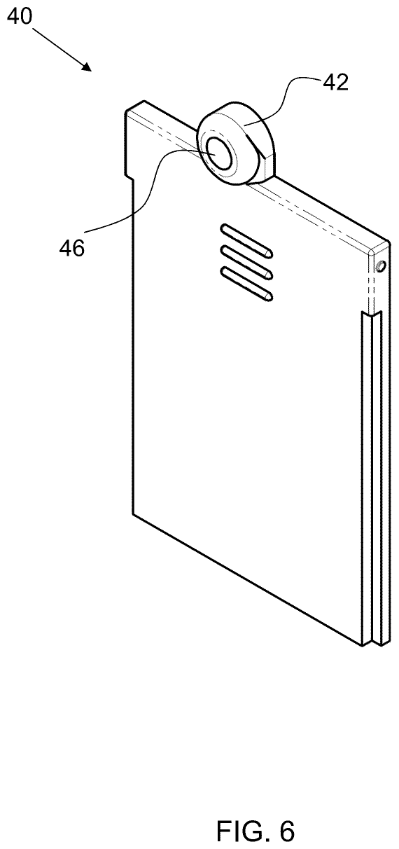

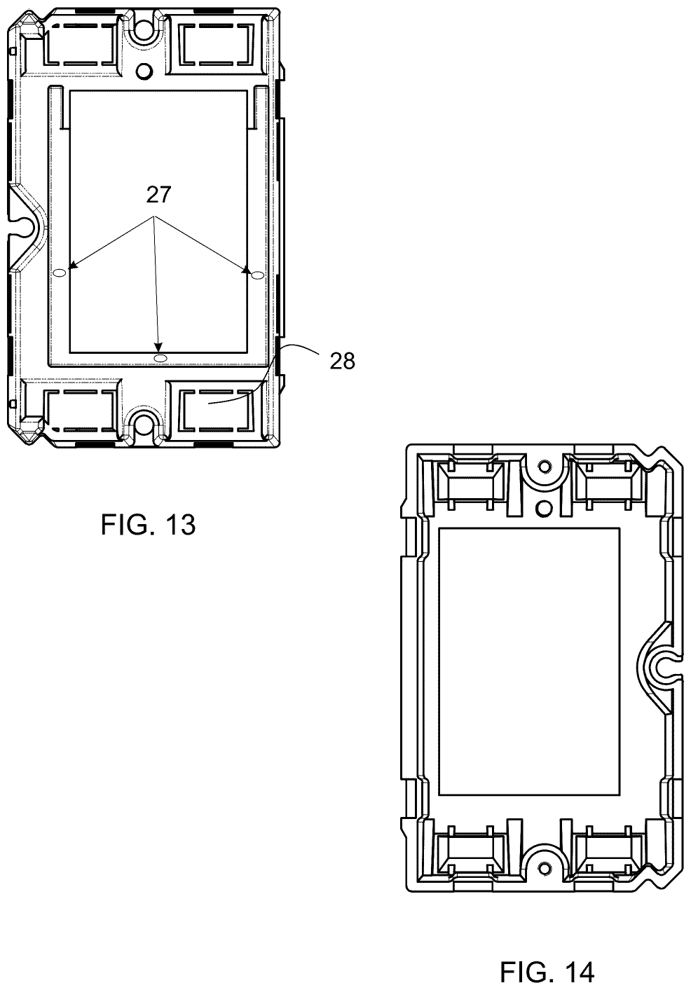

FIG. 13 is a rear view of the junction box having a plurality of cable entry holes 28 and molded channels 27. Cables to the junction box 20 maybe added through cable entry holes 28 located on the top/bottom of the junction box 20. The number of entry cable holes 28 will vary depending on the junction box model, e.g., 1-Gang, 2-Gang, etc. The molded channels 27 allows for the rear cover plate 40 to be attached by sliding it into molded channels along 2 or 3 edges of the junction box 20 that would allow the rear cover plate 40 to be inserted into the molded channels 27. The rear cover plate 20 is then held firmly in place by interference fit or for a more secure installation an added fastener may be used thru the hole 42 in the cover 40 shown in FIG. 6.

While the invention herein disclosed has been described by means of specific embodiments and applications thereof, numerous modifications and variations could be made thereto by those skilled in the art without departing from the scope of the invention set forth in the claims.

1. A junction box assembly comprising:
a non-metallic junction box having:
a junction box front face;
a junction box rear face;
junction box sides defining the junction box front face and the junction box rear face; and
a rear cover plate removably attached to the non-metallic junction box and covering the junction box rear face.

2. The junction box assembly of claim 1, wherein the rear cover plate is non-metallic.

3. The junction box assembly of claim 1, further having:
a hole in the cover plate to attach a fastener; and
a grounding member inserted through the hole in the cover plate.

4. The junction box assembly of claim 1, wherein the junction box having geometric features,
wherein the rear cover plate is mated and is secured to the junction box by means by an interference fit between the rear cover plate and the two or more junction box rear grooves.

5. The junction box assembly of claim 1, wherein the junction box further having one or more holes or slots disposed at the junction box rear face wherein the rear cover plate having one or more protruding pins that are positioned at 90 degrees to the rear cover plate that enter the holes or slots of the junction box rear face, deflect temporarily to allow for entry into said holes or slots, and then return to their original position after full entry into the holes or slots such that the rear cover plate will be retained.

6. The junction box assembly of claim 1, further having a mounting bracket.

7. The junction box assembly of claim 6, comprising:
a fixed mounting bracket plate secured to a framing member by at least one fastener.

8. The junction box assembly of claim 6, further having:
an attachment mounting bracket plate connected to the non-metallic junction box, the attachment mounting bracket plate being rotatably connected to the fixed mounting bracket plate by a mounting bracket hinge.

9. The junction box assembly of claim 8, wherein the attachment mounting bracket plate is formed integrally with the non-metallic junction box.

10. The junction box assembly of claim 1, wherein the junction box further having mounting bracket grooves configured in at least one of the junction box sides,
and wherein the attachment mounting bracket plate mates with the mounting bracket grooves and is threadedly engaged with a mounting bracket screw,
wherein the mounting bracket screw is rotated to translate the mounting bracket along the at least one of the junction box sides.

11. The junction box assembly of claim 7, wherein the attachment mounting bracket plate is rotated relative to the fixed mounting bracket plate to cause the non-metallic junction box to rotate relative to the framing member thereby exposing the junction box rear face.

12. A junction box assembly comprising:
a non-metallic junction box having:
a junction box front face;
a junction box rear face;
junction box sides defining the junction box front face and the junction box rear face;
a rear cover plate removably attached to the non-metallic junction box and covering the junction box rear face; and
an adapter plate secured to the non-metallic junction box and covering a portion of the junction box front face.

13. The junction box assembly of claim 12, wherein the non-metallic junction box is an n-gang junction box wherein the “n” is an integer greater than one,
and wherein securing the adapter plate to the non-metallic junction box causes only a portion of the junction box front face to be accessible.

14. The junction box assembly of claim 12, wherein the adapter plate is secured to the non-metallic junction box by screws, wherein the adapter plate further having:
adapter plate slots; and
adapter plate tabs comprising threaded holes, the adapter plate tabs secured to the adapter plate by interference fits between the adapter plate tabs and the adapter plate slots;
wherein a wiring device is secured to the junction box assembly by threading screws through threaded holes in the wiring device and into the threaded holes of the adapter plate tabs.

15. The junction box assembly of claim 12, wherein the adapter plate further comprises a plaster ring extending past the junction box front face away from the junction box rear face.

16. A vapor proof ring assembly for a junction box, comprising:
a vapor proof ring configured to fit over a junction box;
an engagement mechanism between the vapor proof ring and the junction box; and
the engagement mechanism securing the vapor proof ring to the junction box.

17. The vapor proof ring assembly of claim 16, wherein the engagement mechanism comprises serrated tracks on the junction box and complementary teeth on the vapor proof ring.

18. The vapor proof ring assembly of claim 16 wherein the engagement mechanism may be manually disengaged by lifting the complementary teeth from the serrated tracks so that the vapor proof ring may be moved towards the front of the junction box and removed.

19. The vapor proof ring assembly of claim 16, further having a sealing layer positioned between the vapor proof ring and an adjacent surface, the sealing layer configured to form an airtight barrier.

20. The vapor proof ring assembly of claim 16, wherein the sealing layer is compressible and conforms to irregularities in the adjacent surface to enhance the airtight barrier.
